(19) United States
(12) Patent Application Publication
(10) Pub. No.: US 2012/0261944 A1
(43) Pub. Date: Oct. 18, 2012

(54) Vehicle Seal With Sensor Feedback

(76) Inventor: Craig J. Kreil, Mishawaka, IN (US)

(21) Appl. No.: 13/517,831

(22) Filed: Jun. 14, 2012

Related U.S. Application Data
(63) Continuation-in-part of application No. 12/562,318, filed on Sep. 18, 2009.
(60) Provisional application No. 61/098,127, filed on Sep. 18, 2008.

(51) Int. Cl. B60P 3/355; F16J 15/02

(52) U.S. Cl. 296/175; 277/628

(57) ABSTRACT

A seal is provided for a slide-out room of a recreational vehicle. The slide-out room is movable in a range of positions including a retracted position and an extended position. The seal is compressible between the slide-out room and a side wall of the vehicle and includes at least one sensor capable of detecting a force or a lack thereof on the seal, to indicate if adequate compression of the seal has been achieved in a stop position of the room or if there is an obstruction in between the stop positions.

### CROSS-REFERENCE TO RELATED APPLICATION

This application is a continuation-in-part of U.S. application Ser. No. 12/562,318 filed Sep. 18, 2009, which claims the benefit of U.S. Provisional Patent Application No. 61/098,127 filed Sep. 18, 2008.

### STATEMENT REGARDING FEDERALLY SPONSORED RESEARCH OR DEVELOPMENT

Not applicable.

### FIELD OF THE INVENTION

The invention relates to a seal on a slide-out room of a recreational vehicle.

### BACKGROUND OF THE INVENTION

Recreational vehicles such as travel trailers and motor homes may include a slide-out room to increase the size of the living quarters of the vehicle while also permitting an appropriate size for highway travel. The slide-out room is typically moved by a number of actuators, such as hydraulic cylinders, electric drive screws or electric gear drives located on the recreational vehicle. Slide-out rooms include mechanical or programmable stops to define the retracted and extended positions of the slide-out room. Additionally, slide-out rooms typically include seals at the inside and outside interface with the stationary wall of the vehicle to prevent drafts, moisture and insect intrusion into the living quarters of the recreational vehicle.

The effectiveness of the seals on slide-out rooms can be compromised, however. For example, the seals are not effective if the slide-out room does not stop at a position that is not fully extended or fully retracted. In addition, the seals may assume a ‘set’ position over a number of cycles of extending and retracting the slide-out room. This prevents the seal from adequately compressing against an adjacent surface. Due to the above reasons, a need exists for an improved seal on a slide-out room of a recreational vehicle.

### SUMMARY OF THE INVENTION

The invention provides a seal for a slide-out room of a recreational vehicle. The slide-out room is movable between a retracted position and an extended position. The seal is compressible between the slide-out room and a side wall of the vehicle and includes at least one sensor capable of indicating if adequate compression of the seal has been achieved. In one aspect of the invention, the sensor may be a plurality of membrane switches. The plurality of membrane switches may be capable of indicating if adequate compression has been achieved at multiple areas of the seal. In another aspect of the invention, the seal may be inflatable. In this case, the sensor may be an air pressure sensor.

The sensor may also include the capability of sending a signal to indicate contact with an obstruction. Motion of the slide-out room is preferably stopped in the presence of an obstruction.

The foregoing and other objects and advantages of the invention will appear in the detailed description that follows. In the description, reference is made to the accompanying drawings that illustrate a preferred embodiment of the invention.

### BRIEF DESCRIPTION OF THE DRAWINGS

FIG. 1 is a perspective view of a recreational vehicle with a slide-out room;

FIG. 2 is a perspective view of the recreational vehicle of FIG. 1 showing room slides on the bottom of the vehicle;

FIG. 3 is a sectioned view of the recreational vehicle and the slide-out room from the plane of the line 3-3 of FIG. 1;

FIG. 4 is a front view of the slide-out room of FIG. 1;

FIG. 5 is a sectioned view of the recreational vehicle and the slide-out room from the plane of the line 5-5 in FIG. 1 and illustrating a membrane switch disposed within a slide-out room seal;

FIG. 6 is a sectioned view of the recreational vehicle and the slide-out room from the plane of the line 5-5 in FIG. 1 and illustrating a membrane switch disposed within the slide-out room seal;

FIG. 7 is a front view of an alternative embodiment of the slide-out room; and

FIG. 8 is a sectioned view of the recreational vehicle and the slide-out room from the plane of the line 5-5 in FIG. 1 and illustrating an air pressure sensor disposed within the slide-out room seal.

### DETAILED DESCRIPTION OF THE PREFERRED EMBODIMENT

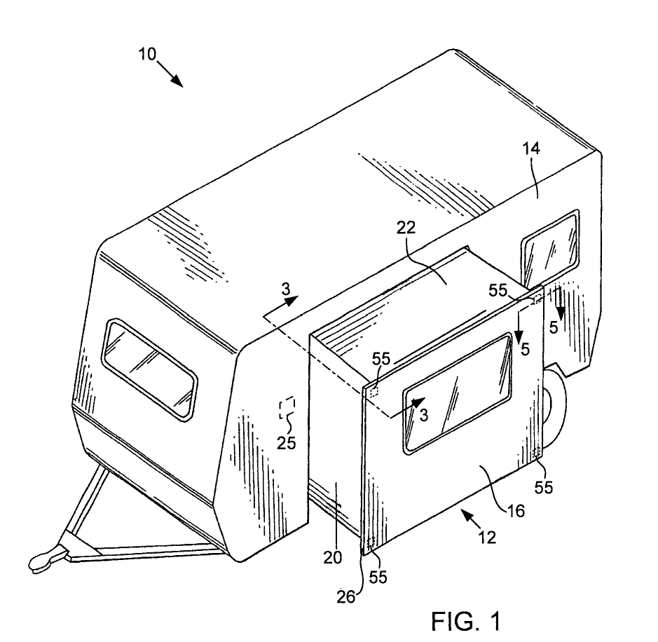

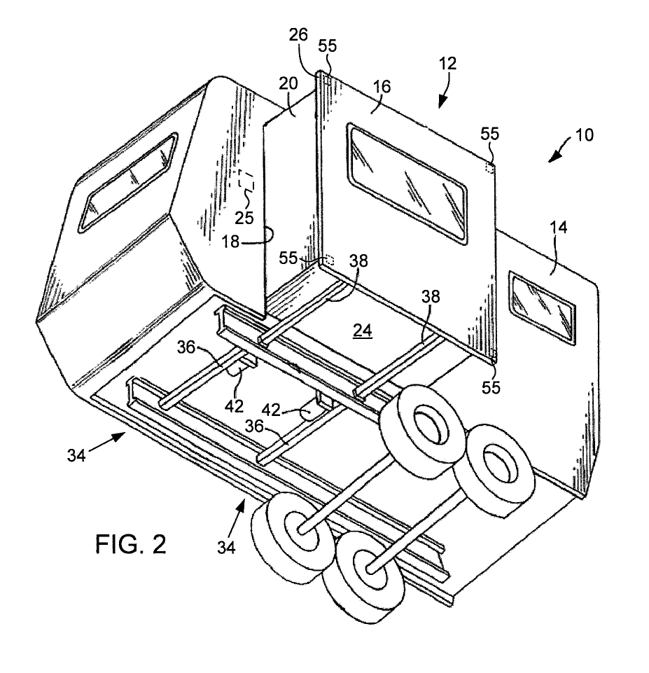

Referring to FIGS. 1 and 2, a recreational vehicle 10 includes a slide-out room 12 located in an opening 18 on a side wall 14. The slide-out room 12 includes a leading wall 16, side walls 20, a ceiling 22, and a floor 24. The leading wall 16 includes a fascia 26. The plane of the fascia 26 is parallel to the respective planes of the opening 18 and the side wall 14. The slide-out room 12 is movable between extended and retracted positions and may include a locking mechanism that prevents the slide-out room 12 from moving unintentionally. The slide out room 12 is stopped by mechanical or programmable stops in the retracted and extended positions. Programmable stops may be positions stored by a controller 25 that defines the retracted and extended positions of the slide-out room 12.

One or more of room slide mechanisms 34 are included above or below the floor of the recreational vehicle 10. The room slides 34 extend and retract the slide-out room 12. The number of room slides 34 is typically between one and four depending on the size of the recreational vehicle 10, the size of the slide-out room 12, and the power output of each room slide 34. Two slides 34 are illustrated for the room 12 in FIG. 2. Each room slide mechanism 34 includes a slide body 36, an extending section 38, mounting supports (not shown), and a drive unit 42. A free end of the extending section 38 attaches to the fascia 26 of the slide-out room 12. The mounting supports attach the slide body 36 to the bottom of the recreational vehicle 10. Both the extending section 38 and the mounting supports can be connected to their respective section by welding or standard fasteners, such as bolts, screws, and the like. Several types of room slides are known in the art and may be used. For example, the room slides may be electric power screws, hydraulic cylinders, electric rack and pinion, cable or chain drive assemblies. If the drive units 42 are electric they may include dynamic brakes to automatically stop the room slides 34 if power is interrupted. The drive unit 42 of each room slide 34 may be operably connected to the controller that ensures synchronized motion of the room slides 34, or synchronization may be provided mechanically.

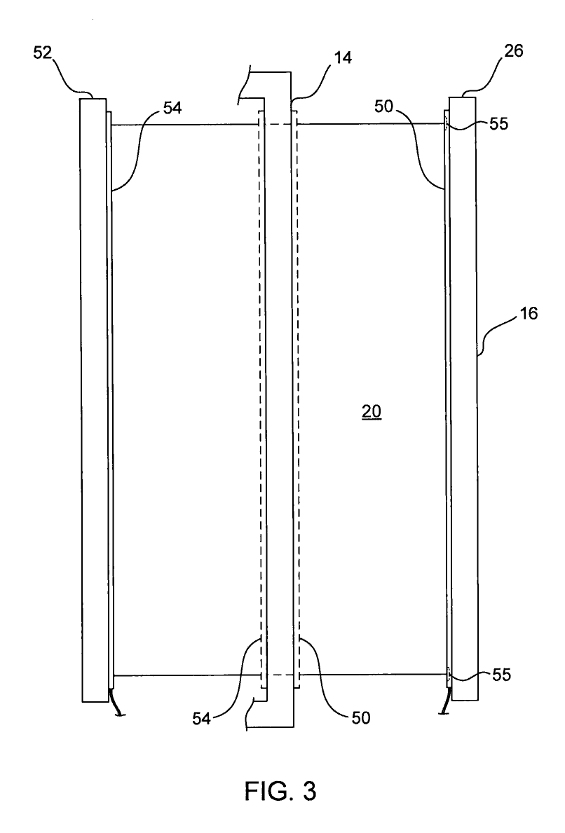

Referring to FIG. 3, the surface of the fascia 26 facing the side wall 14 includes a seal 50. The seal is compressed between the fascia 26 and the exterior surface of the side wall 14 when the slide-out room 12 is retracted. This seal prevents leaks between the cabin of the recreational vehicle 10 and its environment when the slide-out room 12 is retracted. The side walls 20 of the slide-out room 12 also include a flange section 52 located inside the vehicle 10. The surface of the flange section 52 facing the side wall 14 includes a seal 54. The seal prevents leaks between the cabin of the recreational vehicle 10 and its environment when the slide-out room 12 is extended. Alternatively, the seals 50 and 54 may be positioned on the outer and inner surfaces of the side wall 14, respectively. The seals 50 and 54 can include sensors 55 that are operably connected to the controller of the vehicle. This aspect will be discussed in further detail below.

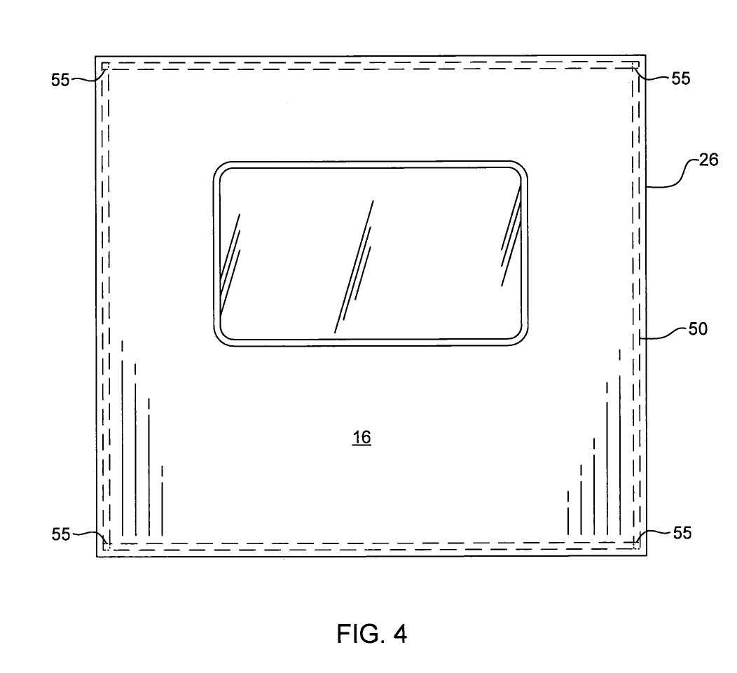

Referring to FIG. 4, the seal 50 extends around the perimeter of the fascia 26 outside of the side walls 20, the ceiling 22, and the floor 24 of the slide-out room 12. The seal 54 also extends around the perimeter of the flange section 52 in a similar manner.

The seals 50 and 54 may be inflatable. The seals 50 and 54 may each include a single inflatable compartment or multiple inflatable compartments. The seals 50 and 54 are preferably deflated or partially deflated when the slide out room 12 moves between the retracted and extended positions. In addition, there is preferably enough space for the seal 50 or 54 to further inflate and provide adequate compression with the side wall 14 when the room is positioned at the retracted or the extended position, respectively.

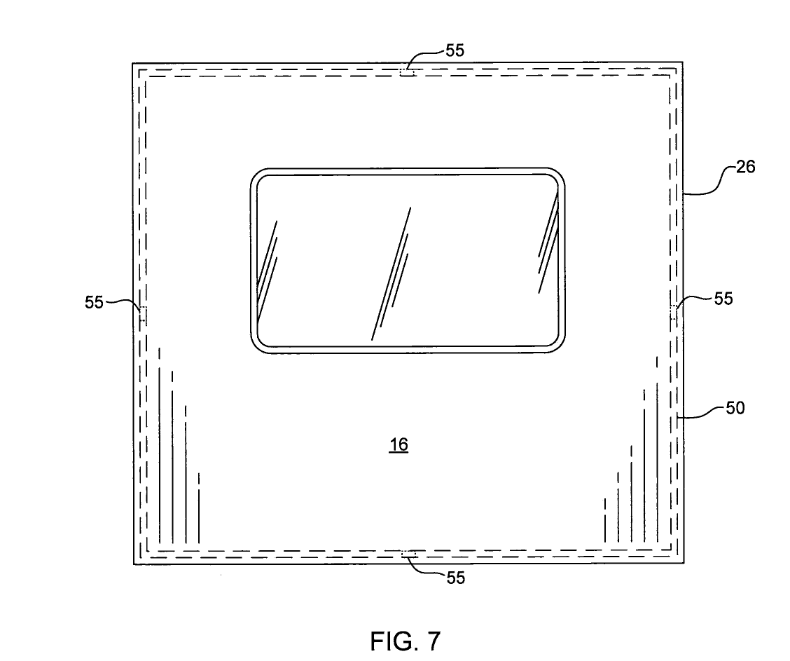

The seals 50 and 54 include sensors capable of providing signals to the controller. These signals permit the controller to determine if adequate seal compression has been established between either seal 50 or 54 and the side wall 14, or the fascia 26 or the interior flange 52. As shown in FIG. 5, the sensors 55 may be, for example, commercially available membrane switches adhered to the external surfaces of the seals 50 and 54. Such membrane switches provide on signals to the controller when opposite sides contact each other and off signals when there is no external force applied to the switch causing its contacts to close. Membrane switches may be used with inflatable or non-inflatable seals 50 and 54. If membrane switches are used, they are preferably used in a manner that permits the controller 25 to determine if adequate seal compression has been achieved at multiple areas on the seal. For example and as shown in FIG. 4, the sensors 55 may be disposed at the four corners of the seal 50. As another example and as shown in FIG. 7, the sensors 55 may be disposed along the four sides of the seal 50 between the corners. The controller 25 also preferably identifies which area is experiencing inadequate seal compression, or seal compression when no seal compression is expected, for example seal compression at an intermediate position indicating an obstruction has been encountered.

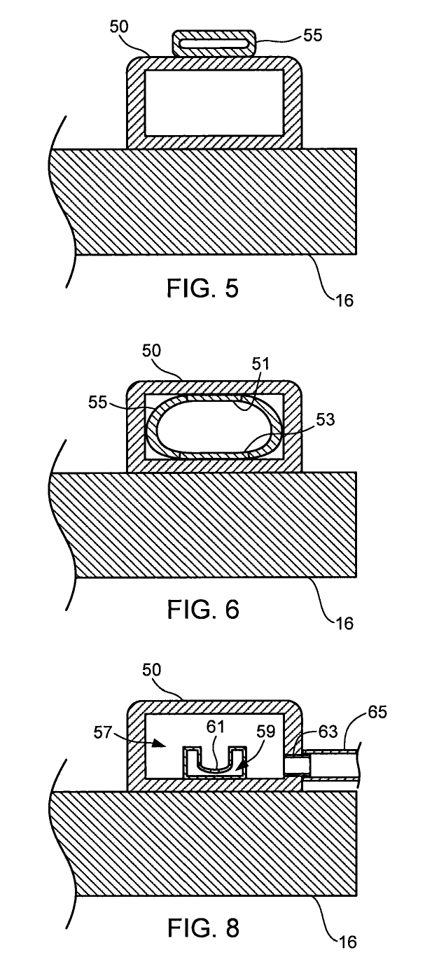

Alternatively and as shown in FIG. 6, the sensors 55 may be membrane switches, such as compressible spring contacts available from Mayser GmbH of Lindenberg, Germany, disposed within internal passageways of the seals 50 and 54. Such spring contacts provide a signal to the controller 25 when opposite sides 51 and 53 contact each other. The sensors 55 may alternatively be other switches located within the internal passageways that are actuated by seal contact with the side wall 14.

Alternatively and as shown in FIG. 8, an air pressure sensor may be disposed within the internal passageways if the seals 50 and 54 are inflatable. Such an air pressure sensor may be a sensor 57 including a vacuum chamber 59 that houses a flexible resistive element 61. The resistive element 61 is also in communication with the internal passageways and is deformed based on the air pressure within the internal passageways. Such deformation changes the resistance of the element 61, which is observed by the controller to determine air pressure changes within the seals 50 and 54 and seal compression.

A single air pressure sensor may be provided for each seal 50 and 54 if each seal 50 and 54 includes a single compartment. An air pressure sensor may be provided for each compartment if the seals 50 and 54 have multiple compartments, such as isolated compartments located at the corners of the seals 50 and 54. In either case, each compartment may have a single port 63 (acting as both an inlet and an outlet) connected to tubing 65 of an air delivery system. Alternatively, each compartment may have separate inlet and outlet ports.

In any case, the air pressure sensors would permit the controller to monitor the air pressure in the seals 50 and 54, and if there are separate compartments in each seal, to monitor the pressure of each compartment and to identify which compartment has an air pressure that is outside of prescribed limits, either too low if in a stop position, indicating inadequate seal compression, or too high if in and intermediate position, indicating an obstruction. If adequate seal compression has not been achieved, the controller may power one or more of the room slides 34 to further compress the seal 50 or 54 against the side wall 14 of the vehicle 10. If an obstruction is sensed, movement of the room would be stopped by the controller until the problem is corrected or a manual reset or override switch is activated.

The seals 50 and 54 may be manufactured and assembled to the slide-out room 12 in various manners. For example, the seals 50 and 54 may first be manufactured using well-known methods, such as extrusion. The sensors 55 may then be inserted into the internal passageways of the seals 50 and 54, and then the internal passageways may be isolated from the outside environment in various manners. For example, a flexible end cap (i.e., additional seal material) may cover the internal passageways or the walls of the seals 50 and 54 on opposite sides of the sensors 55 may be adhered to each other apart from the sensors 55. The seals 50 and 54 may then be adhered to the slide-out room 12. Other manufacturing techniques appropriate for the components described above may alternatively be used.

As mentioned above, the sensors on the seals 50 and 54 are preferably also capable of providing signals to the controller to permit the controller to detect if an obstruction has been caught between the fascia 26 or the interior flange 52 of the slide-out room 12 and the side wall 14 during respective retraction or extension. If membrane switches are used, for example, the controller will stop motion of the slide-out room 12 if a membrane switch is actuated by the contact force of an obstruction. If air pressure sensors are used for inflatable seals 50 and 54, the controller would stop motion of the slide-out room 12 if the air pressure increases suddenly at an intermediate position (short of one of the stop positions).

Alternatively, the sensors may be limited to certain parts of the seals 50 and 54. For example, it may be sufficient to include membrane switches only on the parts of the seals 50 and 54 that extend up the side walls 20 of the slide-out room 12. Similarly, it may not be necessary to provide membrane switches along the entire length up the side walls 20 of the slide-out room 12. As another example, it may be sufficient to provide sensors 55 only at the four corners of the seal 50 shown in FIG. 4. Other sensor arrangements are possible and will be apparent to those skilled in the art.

A controller capable of determining if adequate seal compression has been achieved and detecting obstructions would also require the capability of distinguishing seal compression from obstruction contact. Using programmable stops may be advantageous in this situation. If the slide-out room 12 is near either the retracted or the extended position, the controller could switch to an operating mode in which it is only capable of determining if adequate seal compression has been achieved. Conversely, if the slide-out room 12 is not near either the retracted or the extended position, the controller could switch to an operating mode in which it is only capable of detecting obstructions between the fascia 26 of the slide-out room 12 and the side wall 14.

The present invention should not be limited to the embodiments and illustrations contained herein, but should include modified forms of those embodiments including portions of the embodiments and combinations of elements of different embodiments as come within the scope of the following claims.

1. An apparatus for a slide-out room of a recreational vehicle, the vehicle including a side wall that defines an opening, the slide-out room being positioned in the opening and movable between a retracted position and an extended position, and the slide-out room including a flange having a surface facing the side wall, the apparatus comprising:
a seal supported by the surface facing the side wall and being compressible between the surface and the side wall in a direction in which the slide-out room moves as the slide-out room moves between the retracted position and the extended position, and the seal including at least one sensor capable of indicating compression of at least part of the seal; and
a controller operably connected to move the slide-out room between the retracted position and the extended position and operably connected to the at least one sensor.

2. The apparatus of claim 1, wherein the sensor includes a plurality of membrane switches.

3. The apparatus of claim 2, wherein the plurality of membrane switches are disposed on an external surface of the seal.

4. The apparatus of claim 2, wherein the plurality of membrane switches are disposed within the seal.

5. The apparatus of claim 1, wherein the sensor includes an air pressure sensor.

6. The apparatus of claim 1, wherein the flange is part of a fascia of the slide-out room, and the seal is compressed between the fascia and the side wall when the slide-out room is in a retracted position.

7. The apparatus of claim 1, wherein the seal is compressed between the flange and the side wall when the slide-out room is in an extended position.

8. The apparatus of claim 1, wherein the seal is inflatable.

9. The apparatus of claim 8, wherein the seal is at least partially deflated when the slide-out room moves.

10. A system for a vehicle having a side wall that defines an opening, the system comprising:
a slide-out room positioned in the opening and movable between a retracted position and an extended position, the slide-out room having a flange with a surface that faces the side wall;
at least one actuator capable of exerting a force on the slide-out room to move the slide-out room between the retracted position and the extended position relative to the vehicle;
a controller operably connected to the at least one actuator to control the at least one actuator and thereby move the slide-out room between the retracted position and the extended position relative to the vehicle; and
at least one seal that is compressible between the flange and the side wall in a direction in which the slide-out room moves as the slide-out room moves relative to the vehicle, the seal including at least one sensor capable of sending a signal to the controller to indicate a force on the seal.

11. The system of claim 10, wherein the system includes multiple seals, at least one said seal being compressible against the side wall of the vehicle when the slide-out room is extended, and another of said seals being compressible against the side wall of the vehicle when the slide-out room is retracted.

12. The system of claim 10, wherein the sensor is capable of sending a signal to the controller to indicate contact with an obstruction.

13. The system of claim 10, wherein the sensor includes at least one of a membrane switch or a pressure operated switch.

14. The system of claim 10, wherein the sensor includes a plurality of membrane switches positioned at different positions around the seal.

15. The system of claim 14, wherein the plurality of membrane switches is capable of sending signals to the controller to indicate a force or lack thereof on the seal at the position of each of the membrane switches and the controller can identify the position of the force or lack thereof and with that information control the actuator accordingly.

16. The system of claim 10, wherein the seal is inflatable and the sensor is an air pressure sensor.

17. A method for moving a slide-out room of a vehicle having a side wall that defines an opening, the slide-out room being positioned in the opening and movable between a retracted position and an extended position, the slide-out room having a seal including a sensor and being supported on a surface of a flange facing the side wall, and the seal being compressible between the flange and the side wall, comprising the steps of:
exerting a force on the slide-out room to move the slide-out room in the opening between the retracted position and the extended position relative to the vehicle;
sending a signal from the sensor to a controller to indicate a force acting on the seal by compressing the seal between the flange and the side wall or lack thereof; and
subsequently exerting an additional force on the slide-out room to alleviate inadequate compression of the seal between the flange and the side wall in response to the signal indicating a lack of force on the seal.

18. The method of claim 17, further including the step of detecting obstructions between the slide-out room and a side wall of the vehicle by the sensor detecting a force on the seal.

19. The method of claim 18, further including the step of stopping motion of the slide-out room in the presence of a detected obstruction between the slide-out room and the side wall of the vehicle.

20. The method of claim 18, further comprising the steps of repeatedly moving the slide-out room between the retracted position and the extended position relative to the vehicle and switching between determining compression adequacy of the seal and detecting obstructions while the slide-out room repeatedly moves between the retracted position and the extended position.
